(19) United States
(12) Patent Application Publication
(10) Pub. No.: US 2026/0357825 A1
(43) Pub. Date: Nov. 12, 2026

(54) FLUID PRESSURE CONTROL DEVICE

(71) Applicant: KYB Corporation, Tokyo (JP)

(72) Inventors: Toshiyuki KITANI, Yamaguchi (JP); Nobuyoshi YOSHIDA, Nagano (JP)

(73) Assignee: KYB Corporation, Tokyo (JP)

(21) Appl. No.: 19/136,003

(22) PCT Filed: Nov. 15, 2023
(86) PCT No.: PCT/JP2023/041040

§ 371 Date: Jun. 5, 2025

(30) Foreign Application Priority Data
Dec. 15, 2022 (JP) 2022-200315

(51) Int. Cl. F15B 11/17; F15B 11/16; F15B 13/08

(52) U.S. Cl. CPC F15B 11/17; F15B 11/165; F15B 13/0814; F15B 2211/20576; F15B 2211/25

(57) ABSTRACT

A fluid pressure control device includes a first circuit system, a second circuit system, and a valve block that has a first region in which first control valves are accommodated and a second region in which second control valves are accommodated. The first circuit system includes a first neutral cut valve that allows or shuts off the communication between a first neutral passage and a tank. The second circuit system includes a second neutral cut valve that allows or shuts off the communication between the second neutral passage and the tank. The first neutral cut valve and the second neutral cut valve are accommodated in either the first region or the second region.

### TECHNICAL FIELD

The present invention relates to a fluid pressure control device.

### BACKGROUND ART

JP2019-219003A discloses a fluid pressure control device including a first circuit system connected to a first pump and supplied with hydraulic oil discharged from the first pump, and a second circuit system connected to the second pump and supplied with the hydraulic oil discharged from the second pump. The second circuit system of the fluid pressure control device described in JP2019-219003A includes a second neutral passage for guiding the hydraulic oil supplied from the second pump to a tank, a plurality of actuator control valves connected in series to the second neutral passage, and a neutral cut valve connected to the second neutral passage downstream of the actuator control valve.

### SUMMARY OF INVENTION

In the fluid pressure control device described in JP2019-219003A, the first circuit system may also be provided with a neutral cut valve that allow or shut off communication between a first neutral passage and a discharge passage. In this case, when the neutral cut valve is provided in a valve block in which the first circuit system is accommodated, a size of the valve block is increased by a space for accommodating the neutral cut valve.

The present invention has been made in view of the above problems, and an object thereof is to prevent an increase in size of a fluid pressure control device when a neutral cut valve is newly added.

### MEANS FOR SOLVING THE PROBLEM

According to one aspect of the present invention, a fluid pressure control device includes: a first circuit system connected to a first pump and including at least one first control valve for controlling an actuator; a second circuit system connected to a second pump and including at least one second control valve for controlling the actuator; and a valve block including a first region in which the first control valve is accommodated and a second region in which the second control valve is accommodated. The first circuit system includes a first neutral passage configured to recirculate a working fluid of the first pump to a tank when all the first control valves are in neutral positions, and a first neutral cut valve provided downstream of the first control valve in the first neutral passage and configured to allow or shut off communication between the first neutral passage and the tank. The second circuit system includes a second neutral passage configured to recirculate a working fluid of the second pump to the tank when all the second control valves are in neutral positions, and a second neutral cut valve provided downstream of the second control valve in the second neutral passage and configured to allow or shut off communication between the second neutral passage and the tank. The first neutral cut valve and the second neutral cut valve are accommodated in either the first region or the second region.

### BRIEF DESCRIPTION OF DRAWINGS

FIG. 1 is a circuit diagram showing a fluid pressure control device according to an embodiment of the present invention.

FIG. 2 is a structural cross-sectional view of the vicinity of a first neutral cut valve and a second neutral cut valve according to the embodiment of the present invention.

FIG. 3 is a diagram for illustrating the concept of a first region and a second region in the fluid pressure control device according to the embodiment of the present invention.

### DESCRIPTION OF EMBODIMENTS

Hereinafter, a fluid pressure control device 100 according to an embodiment of the present invention will be described with reference to the drawings.

The fluid pressure control device 100 is used, for example, in a working machine such as a power shovel. Here, a case where the working machine is a power shovel will be described, and the fluid pressure control device 100 is also applicable to other work machines such as a wheel loader. In the fluid pressure control device 100, hydraulic oil is used as a working fluid, and another fluid such as working water may be used as the working fluid.

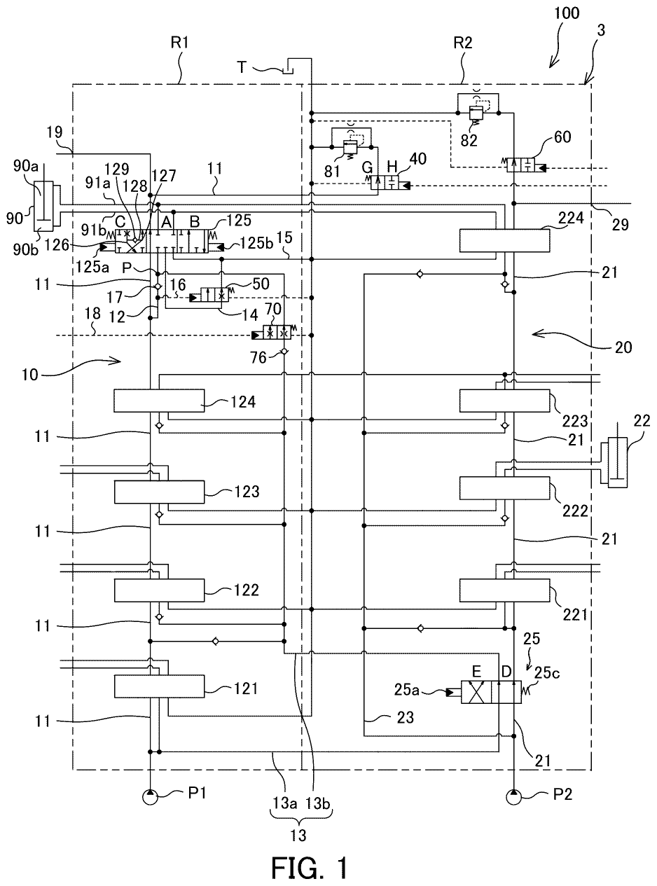

As shown in FIG. 1, the fluid pressure control device 100 includes a first circuit system 10 connected to a first pump P1 and supplied with hydraulic oil from the first pump P1, and a second circuit system 20 connected to a second pump P2 and supplied with hydraulic oil from the second pump P2.

The first circuit system 10 includes a first neutral passage 11 that guides, to a tank T, the hydraulic oil supplied from the first pump P1, first control valves 121 to 125 that are connected in series to the first neutral passage 11, and a first parallel passage 13 that is branched from the first neutral passage 11 upstream from the first control valves 121 to 125. The first control valves 121 to 125 are connected in series by the first neutral passage 11, and are connected in parallel by the first parallel passage 13.

The hydraulic oil discharged from the first pump P1 is guided to a first traveling control valve 121, an auxiliary control valve 122, a turning control valve 123, a boom dual speed control valve 124, and an arm single speed control valve 125 in this order from upstream. The first traveling control valve 121 controls supply and discharge of hydraulic oil to and from a travel motor provided on a left side of a vehicle body of a power shovel (not shown). The auxiliary control valve 122 controls supply and discharge of hydraulic oil to and from an actuator that drives an attachment such as a breaker or a crusher attached instead of a bucket. The turning control valve 123 controls supply and discharge of hydraulic oil to and from a turning motor that turns a turning body disposed at an upper portion of the vehicle body. The boom dual speed control valve 124 controls supply and discharge of hydraulic oil to and from an actuator that drives a boom. The arm single speed control valve 125 controls supply and discharge of hydraulic oil to and from an actuator (an arm cylinder 90) that drives an arm.

In the first circuit system 10, when all the first control valves 121 to 125 are in neutral positions, the hydraulic oil supplied from the first pump P1 is recirculated to the tank T by the first neutral passage 11. On the other hand, when at least one of the first control valves 121 to 125 is at an operating position, the communication between the first pump P1 in the first neutral passage 11 and the tank T is shut off.

In the first circuit system 10, even when any one of the first control valves 121 to 124 is switched to the operating position and the communication between the first pump P1 in the first neutral passage 11 and the tank T is shut off, the hydraulic oil supplied from the first pump P1 can be supplied to each of the first control valves 122 to 125 through the first parallel passage 13.

The first circuit system 10 further includes a first neutral cut valve 40 that is provided downstream of the first control valves 121 to 125 in the first neutral passage 11 and allows or shuts off communication between the first neutral passage 11 and the tank T, and a first relief valve 81 that is provided downstream of the first neutral cut valve 40 in the first neutral passage 11 and defines a maximum pressure in the first neutral passage 11. When the first neutral cut valve 40 is at a G position (a normal position) shown in FIG. 1, the first neutral cut valve 40 allows the communication between the first neutral passage 11 and the tank T, and when the first neutral cut valve 40 is at a H position (a shut-off position), the first neutral cut valve 40 shuts off the communication between the first neutral passage 11 and the tank T.

Next, the operation of the first neutral cut valve 40 will be specifically described.

In a state where a pilot pressure is not supplied, the first neutral cut valve 40 is at the G position (the normal position) shown in FIG. 1. In this state, the hydraulic oil flowing into the first neutral cut valve 40 from the downstream of the arm single speed control valve 125 in the first neutral passage 11 is recirculated to the tank T. That is, when the first neutral cut valve 40 is at the G position (the normal position), the first neutral passage 11 and the tank T communicate with each other.

When the pilot pressure is supplied to the first neutral cut valve 40 from this state, the first neutral cut valve 40 is switched to the H position (the shut-off position) shown in FIG. 1. In this state, the hydraulic oil flowing into the first neutral cut valve 40 from the downstream of the arm single speed control valve 125 in the first neutral passage 11 is prevented from flowing out to the tank T. That is, by switching the first neutral cut valve 40 to the H position (the shut-off position), the communication between the first neutral passage 11 and the tank T is shut off. Accordingly, the hydraulic oil flowing through the first neutral passage 11 is guided to a first external output port 19 branched from between the arm single speed control valve 125 in the first neutral passage 11 and the neutral cut valve 40. The hydraulic oil guided to the first external output port 19 is used for driving a hydraulic device.

Next, the arm single speed control valve 125 will be described with reference to FIG. 1.

As shown in FIG. 1, the arm single speed control valve 125 is connected to the first neutral passage 11, a supply passage 12 that branches from the first neutral passage 11 and supplies hydraulic oil for driving the arm cylinder 90, a first cylinder passage 91a that communicates with a high load side pressure chamber 90a of the arm cylinder 90, a second cylinder passage 91b that communicates with a low load side pressure chamber 90b of the arm cylinder 90, a first tank passage 14 that discharges hydraulic oil in the pressure chamber 90a to the tank T, and a second tank passage 15 that discharges hydraulic oil in the pressure chamber 90b to the tank T.

The first parallel passage 13 (a first parallel downstream passage 13b) joins the supply passage 12. A check valve 17 for preventing backflow of the hydraulic oil is provided upstream of a merging portion P in the supply passage 12 between the supply passage 12 and the first parallel passage 13 (the first parallel downstream passage 13b). A check valve 76 for preventing backflow of the hydraulic oil and a flow rate control valve 70 for controlling a flow rate of the hydraulic oil passing through the first parallel passage 13 are provided upstream of the merging portion P in the first parallel passage 13 between the supply passage 12 and the first parallel passage 13 (the first parallel downstream passage 13b).

The first tank passage 14 is provided with a regeneration release valve 50 that controls a flow rate of the hydraulic oil passing through the first tank passage 14 in accordance with a pilot pressure. The function of the regeneration release valve 50 will be described later.

The arm single speed control valve 125 is switched to three positions, that is, a neutral position A shown in FIG. 1, a high load side operating position B shown on the right side of FIG. 1, and a low load side operating position C shown on the left side of FIG. 1. The positions A, B, and C of the arm single speed control valve 125 are switched in accordance with the pilot pressure supplied to pilot chambers 125a and 125b provided at both ends of the arm single speed control valve 125. When the pilot pressure does not act on any of the pilot chambers 125a and 125b, the arm single speed control valve 125 is switched to the neutral position A by a biasing force of springs 125c provided on both sides of the arm single speed control valve 125. When the pilot pressure is supplied to the pilot chamber 125b, the arm single speed control valve 125 is switched to the high load side operating position B, and when the pilot pressure is supplied to the pilot chamber 125a, the arm single speed control valve 125 is switched to the low load side operating position C.

At the neutral position A, the first neutral passage 11 is connected to the tank T, and the other passage is shut off. Accordingly, the hydraulic oil is not supplied to and discharged from the pressure chambers 90a and 90b of the arm cylinder 90, and the arm cylinder 90 is held at the position.

At the high load side operating position B, the first neutral passage 11 is shut off, the supply passage 12 is connected to the first cylinder passage 91a, and the second cylinder passage 91b is connected to the second tank passage 15. Accordingly, the hydraulic oil discharged from the first pump P1 is supplied from the first neutral passage 11 and the first parallel passage 13 (the first parallel downstream passage 13b) to the pressure chamber 90a through the supply passage 12 and the first cylinder passage 91a. The hydraulic oil in the pressure chamber 90b is discharged to the tank T through the second cylinder passage 91b and the second tank passage 15.

At the low load side operating position C, the first neutral passage 11 is shut off, the supply passage 12 is connected to the second cylinder passage 91b, and the first cylinder passage 91a is connected to the first tank passage 14. Accordingly, the hydraulic oil discharged from the first pump P1 is supplied from the first neutral passage 11 and the first parallel passage 13 to the pressure chamber 90b through the supply passage 12 and the second cylinder passage 91b. The hydraulic oil in the pressure chamber 90a is discharged to the tank T through the first cylinder passage 91a and the first tank passage 14. At this time, the flow rate of the hydraulic oil discharged to the tank T through the first tank passage 14 is controlled by the regeneration release valve 50.

A first internal passage 126 that connects the first cylinder passage 91a and the first tank passage 14 at the low load side operating position C, a second internal passage 127 that connects the supply passage 12 and the second cylinder passage 91b, and a regeneration passage 128 that connects the first internal passage 126 and the second internal passage 127 are formed in the arm single speed control valve 125. The regeneration passage 128 is provided with a check valve 129 that allows only a flow from the first internal passage 126 to the second internal passage 127. Accordingly, the hydraulic oil discharged from the pressure chamber 90a can be regenerated in the pressure chamber 90b through the regeneration passage 128. The first internal passage 126 is provided with a restrictor that regulates the flow rate of the hydraulic oil discharged from the pressure chamber 90a.

Next, the operation of the regeneration release valve 50 will be described.

When the arm single speed control valve 125 is switched to the low load side operating position C, the regeneration release valve 50 adjusts the flow rate of the hydraulic oil returned from the high load side pressure chamber 90a to the tank T through the first tank passage 14. Specifically, when the pilot pressure is supplied to the pilot chamber 125a of the arm single speed control valve 125, the arm single speed control valve 125 is switched to the low load side operating position C. Accordingly, the hydraulic oil in the high load side pressure chamber 90a of the arm cylinder 90 flows out to the tank T through the first cylinder passage 91a, the first internal passage 126, the first tank passage 14, and the regeneration release valve 50.

When the pilot pressure acting on a pilot pressure chamber of the regeneration release valve 50 from the supply passage 12 through the pilot passage 16 is low, a valve body of the regeneration release valve 50 blocks a part of the flow passage, so that the flow passage is narrowed. In this state, the flow rate of the hydraulic oil that can pass through the regeneration release valve 50 is small. As a result, most of the hydraulic oil discharged from the pressure chamber 90a is regenerated in the pressure chamber 90b through the regeneration passage 128.

When the pilot pressure acting on an internal pilot pressure chamber 55 increases from this state, the valve body moves against a biasing force of a return spring, so that an area of the flow passage increases. As a result, the flow rate of the hydraulic oil that can pass through the regeneration release valve 50 increases, and a flow rate of the hydraulic oil that is regenerated in the pressure chamber 90b from the pressure chamber 90a through the regeneration passage decreases. When the pilot pressure acting on the pilot pressure chamber of the regeneration release valve 50 further increases, the valve body further moves against the biasing force of the return spring. Accordingly, the flow rate of the hydraulic oil that can pass through the first tank passage 14 further increases. As a result, the hydraulic oil is not regenerated in the pressure chamber 90b from the pressure chamber 90a through the regeneration passage 128, and the entire amount of the hydraulic oil in the pressure chamber 90a is discharged to the tank T.

As described above, the regeneration release valve 50 adjusts the flow rate of the hydraulic oil passing through the first tank passage 14 in accordance with a pilot pressure acting on the pilot pressure chamber, thereby adjusting the flow rate of the hydraulic oil regenerated from the pressure chamber 90a to the pressure chamber 90b through the regeneration passage 128.

As described above, in the fluid pressure control device 100 including the regeneration release valve 50 of an internal pilot type, when the pressure of the hydraulic oil in the supply passage 12 decreases, that is, when the pilot pressure decreases due to the combined operation of the cylinder or the like, the regeneration release valve 50 can cause the hydraulic oil in the pressure chamber 90a to be regenerated in the pressure chamber 90b by restricting the first tank passage 14. On the other hand, when the pressure of the hydraulic oil in the supply passage 12 is high (does not decrease), that is, when the pilot pressure is high due to a single operation of the arm cylinder 90 or the like, the regeneration release valve 50 opens the first tank passage 14, so that the hydraulic oil in the pressure chamber 90a is discharged to the tank T without being regenerated in the pressure chamber 90b. In the present embodiment, a case where the regeneration release valve 50 is of the internal pilot type has been described as an example, and the regeneration release valve 50 may be of an external pilot type.

Next, the operation of the flow rate control valve 70 will be described.

The flow rate control valve 70 is provided on the first parallel passage 13 (the first parallel downstream passage 13b). The flow rate control valve 70 adjusts a flow rate of the hydraulic oil flowing through the first parallel downstream passage 13b in accordance with a pressure (a pilot pressure) of the hydraulic oil supplied to the pilot pressure chamber from the outside through the pilot passage 18. Specifically, in the flow rate control valve 70, a flow rate of the hydraulic oil passing through the flow rate control valve 70 (a flow rate of the first parallel downstream passage 13b) decreases as the pressure of the hydraulic oil supplied to the pilot pressure chamber increases. The hydraulic oil flowing through the first parallel downstream passage 13b is supplied to the arm cylinder 90 through the supply passage 12 and the arm single speed control valve 125. Therefore, the flow rate of the hydraulic oil supplied to the arm cylinder 90 can be controlled by controlling the flow rate of the hydraulic oil passing through the flow rate control valve 70. Accordingly, for example, when a plurality of actuators including the arm cylinder 90 are operated in combination, by limiting the flow rate of the hydraulic oil supplied to the arm cylinder 90, the hydraulic oil corresponding to the limited flow rate can be supplied to the other actuators. As a result, when the plurality of actuators are operated in combination, it is possible to avoid a situation where only the arm cylinder 90 is driven in advance.

Next, the second circuit system 20 will be described with reference to FIG. 1.

The second circuit system 20 includes a second neutral passage 21 that guides, to the tank T, the hydraulic oil supplied from the second pump P2, a plurality of second control valves 221 to 224 that are connected in series to the second neutral passage 21, and a second parallel passage 23 that is branched from the second neutral passage 21 upstream from the second control valves 221 to 224. The second control valves 221 to 224 are connected in series by the second neutral passage 21, and are connected in parallel by the second parallel passage 23.

The hydraulic oil discharged from the second pump P2 is guided to a second traveling control valve 221, a bucket control valve 222, a boom single speed control valve 223, and an arm dual speed control valve 224 in this order from upstream. The second traveling control valve 221 controls supply and discharge of hydraulic oil to and from a travel motor provided on a right side of a vehicle body of a power shovel (not shown). The bucket control valve 222 controls supply and discharge of hydraulic oil to and from an actuator that drives a bucket. The boom single speed control valve 223 controls supply and discharge of hydraulic oil to and from an actuator that drives a boom. The arm dual speed control valve 224 controls supply and discharge of hydraulic oil to and from an actuator that drives an arm.

In the second circuit system 20, when all the second control valves 221 to 224 are in neutral positions, the hydraulic oil supplied from the second pump P2 is recirculated to the tank T by the second neutral passage 21. On the other hand, when at least one of the second control valves 221 to 224 is at the operating position, the communication between the second pump P2 in the second neutral passage 21 and the tank T is shut off.

In the second circuit system 20, even when any one of the second control valves 221 to 223 is switched to the operating position and the communication between the second pump P2 in the second neutral passage 21 and the tank T is shut off, the hydraulic oil supplied from the second pump P2 can be supplied to each of the second control valves 222 to 224 through the second parallel passage 23.

The second circuit system 20 further includes a second neutral cut valve 60 that is provided downstream of the arm dual speed control valve 224 in the second neutral passage 21 and allows or shuts off the communication between the second neutral passage 21 and the tank T, and a second relief valve 82 that is provided downstream of the second neutral cut valve 60 in the second neutral passage 21 and defines a maximum pressure in the second neutral passage 21. The second neutral cut valve 60 and the second relief valve 82 have the same configuration as the first neutral cut valve 40 and the first relief valve 81, respectively.

The second circuit system 20 further includes a second external output port 29 that communicates with the second neutral passage 21 downstream of the arm dual speed control valve 224 and upstream of the second neutral cut valve 60 and can supply the hydraulic oil discharged from the second pump P2 to the outside. Since the function of the second neutral cut valve 60 is the same as that of the first neutral cut valve 40, the description thereof will be omitted.

The second circuit system 20 further includes a straight traveling control valve 25 that is connected to the second neutral passage 21 downstream of a branch point between the second neutral passage 21 and the second parallel passage 23 and upstream of the second travel control valve 221. The first parallel passage 13 is connected to the straight traveling control valve 25. The first parallel passage 13 includes a first parallel upstream passage 13a that connects the first pump P1 and the straight traveling control valve 25, and a first parallel downstream passage 13b that connects the straight traveling control valve 25 and the first control valves 122 to 125.

The straight traveling control valve 25 is switched between two positions, that is, a normal position D shown on the right side of FIG. 1 and a straight traveling position E shown on the left side of FIG. 1. The positions D and E of the straight traveling control valve 25 are switched in accordance with the pilot pressure supplied to pilot chambers 25a provided at both ends of the straight traveling control valve 25. When the pilot pressure does not act on the pilot chamber 25a, the straight traveling control valve 25 is switched to the normal position D by the biasing force of springs 25b. When the pilot pressure is supplied to the pilot chamber 25a, the straight traveling control valve 25 is switched to the straight traveling position E.

In the normal position D, the first parallel upstream passage 13a of the first parallel passage 13 is connected to the first parallel downstream passage 13b of the first parallel passage 13, and the second neutral passage 21 is connected to the second pump P2. Accordingly, the hydraulic oil discharged from the first pump P1 is supplied to the first control valves 121 to 125 through the first neutral passage 11 and the first parallel passage 13. The hydraulic oil discharged from the second pump P2 is supplied to the second control valves 221 to 224 through the second neutral passage 21 and the second parallel passage 23. That is, when only the travel motor is operated, the hydraulic oil discharged from the first pump P1 is supplied to the first traveling control valve 121, and the hydraulic oil discharged from the second pump P2 is supplied to the second traveling control valve 221.

At the straight traveling position E, the first parallel upstream passage 13a of the first parallel passage 13 is connected to the second neutral passage 21 downstream of the straight traveling control valve 25, and the first parallel downstream passage 13b is connected to the second pump P2. That is, when the travel motor and an actuator other than the travel motor are operated simultaneously, the hydraulic oil discharged from the first pump P1 is supplied to the first traveling control valve 121 and the second traveling control valve 221, and the hydraulic oil discharged from the second pump P2 is supplied to other first control valves 122 to 125 and other second control valves 222 to 224. Therefore, at the straight traveling position E, even if the travel motor and the actuator other than the travel motor are operated simultaneously, a circuit for the travel motor and a circuit of the actuator other than the travel motor are independent from each other, so that the traveling straightness of the vehicle body is ensured.

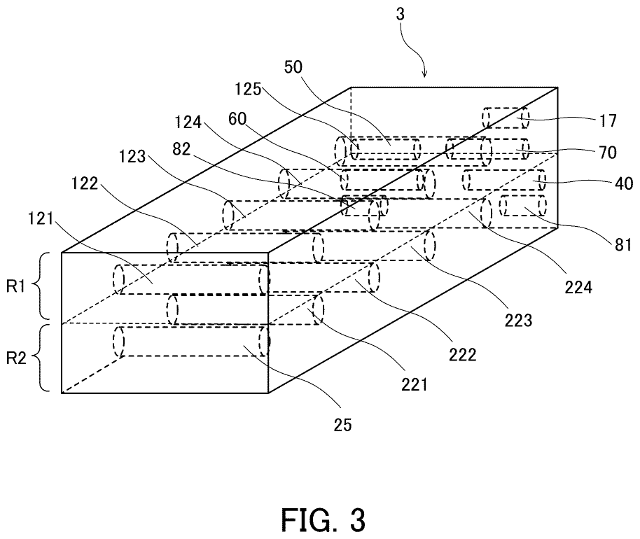

As shown in FIG. 1, in the fluid pressure control device 100, each valve of the first circuit system 10 and the second circuit system 20 is accommodated in one valve block 3. Specifically, as illustrated in FIG. 3, the valve block 3 includes a first region R1 in which the first control valves 121 to 125 of the first circuit system 10 are accommodated, and a second region R2 in which the second control valves 221 to 224 of the second circuit system 20 and the straight traveling control valve 25 are accommodated. In the present embodiment, the first region R1 and the second region R2 are vertically divided in a longitudinal direction of the valve block 3.

As illustrated in FIG. 3, the first control valves 121 to 125 of the first circuit system 10 are arranged in the longitudinal direction of the valve block 3 in the first region R1. The second control valves 221 to 224 of the second circuit system 20 are arranged in the longitudinal direction of the valve block 3 in the second region R2.

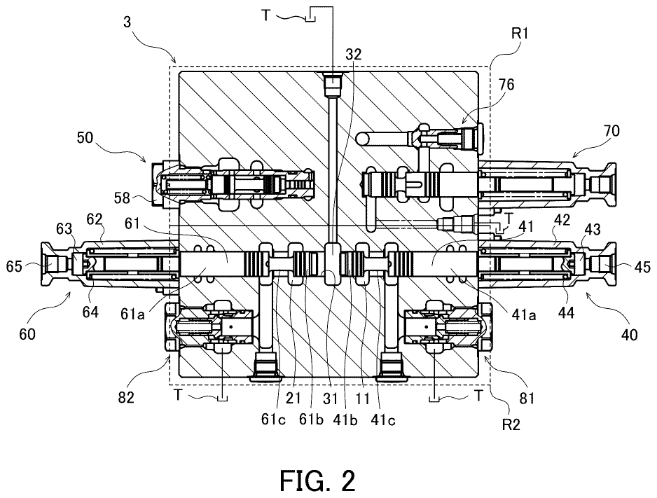

Next, a specific structure of the first neutral cut valve 40 and the second neutral cut valve 60 will be described with reference to FIG. 2. FIG. 2 is a cross-sectional view showing a cross section when the first neutral cut valve 40 and the second neutral cut valve 60 are at the normal position. The configurations of the regeneration release valve 50, the flow rate control valve 70, the check valve 76, and the first and second relief valves 81 and 82 are common, and the descriptions thereof will be omitted.

As shown in FIG. 2, the valve block 3 is provided with a first accommodating hole 31 in which the spool 41 serving as a first spool of the first neutral cut valve 40 and the spool 61 serving as a second spool of the second neutral cut valve 60 are accommodated. The first accommodating hole 31 is formed as a cylindrical through hole opened in both side surfaces of the valve block 3.

The first neutral cut valve 40 includes a spool 41 that is accommodated in the first accommodating hole 31 and allows or shuts off the communication between the first neutral passage 11 and the tank T, a pilot pressure chamber 43 that is provided on one end side of the spool 41 and is formed by the valve block 3 and the cap member 42, and a return spring 44 that is provided in the pilot pressure chamber 43 and biases the spool 41 in a direction (a rightward direction in FIG. 2) in which the first neutral passage 11 and the tank T communicate with each other. The cap member 42 is provided with a pilot port 45 for supplying and discharging pilot pressure to and from the pilot pressure chamber 43.

The spool 41 includes a first land portion 41a and a second land portion 41b that slide along an inner circumferential surface of the first accommodating hole 31, and an annular groove 41c that is formed between the first land portion 41a and the second land portion 41b. When the first land portion 41a moves in the first accommodating hole 31, the first neutral passage 11 is opened and closed.

The second neutral cut valve 60 includes a spool 61 that is accommodated in the first accommodating hole 31 and shuts off or allows the communication between the second neutral passage 21 and the tank T, a pilot pressure chamber 63 that is provided on one end side of the spool 61 and is formed by the valve block 3 and the cap member 62, and a return spring 64 that is provided in the pilot pressure chamber 63 and biases the spool 61 in a direction (a leftward direction in FIG. 2) in which the second neutral passage 21 and the tank T communicates with each other. The cap member 62 is provided with a pilot port 65 for supplying and discharging pilot pressure to and from the pilot pressure chamber 63.

The spool 61 includes a first land portion 61a and a second land portion 61b that slide along the inner circumferential surface of the first accommodating hole 31, and an annular groove 61c that is formed between the first land portion 61a and the second land portion 61b. When the first land portion 61a moves in the first accommodating hole 31, the second neutral passage 21 is opened and closed.

A drain chamber 32 communicating with the tank T is formed between the other end of the spool 41 and the spool 61 in the first accommodating hole 31.

In the fluid pressure control device 100 according to the present embodiment, the first neutral cut valve 40 is provided in the second region R2. In the fluid pressure control device 100 according to the present embodiment, the first circuit system 10 includes the regeneration release valve 50 and the flow rate control valve 70, and the regeneration release valve 50 and the flow rate control valve 70 are provided in the first region R1. Therefore, for example, when the first neutral cut valve 40 is disposed in the first region R1, it is necessary to newly secure a space on an upper side of the cross section shown in FIG. 2, or to newly secure a space by, for example, extending the valve block 3 in the longitudinal direction. Since the second circuit system 20 does not include the regeneration release valve 50 and the flow rate control valve 70, the second region R2 has a sufficient space. In the fluid pressure control device 100 according to the present embodiment, the first neutral cut valve 40 is provided in the second region R2. Accordingly, there is no need to newly secure a space for accommodating the first neutral cut valve 40. Accordingly, even when the first neutral cut valve 40 is provided, it is possible to prevent an increase in size of the fluid pressure control device 100.

In the fluid pressure control device 100, the spool 41 of the first neutral cut valve 40 and the spool 61 of the second neutral cut valve 60 are accommodated in the same first accommodating hole 31. Accordingly, the number of processing steps can be reduced as compared with a case where the spool 41 and the spool 61 are provided in separate accommodating holes. Further, in the fluid pressure control device 100, the spool 41 of the first neutral cut valve 40 and the spool 61 of the second neutral cut valve 60 are accommodated in the same first accommodating hole 31, so that the spool 41 and the spool 61 are disposed coaxially. Accordingly, an increase in size of the fluid pressure control device 100 can be prevented as compared with a case where the spool 41 of the first neutral cut valve 40 and the spool 61 of the second neutral cut valve 60 are displaced from each other.

In the fluid pressure control device 100 according to the above embodiment, a case where the spool 41 of the first neutral cut valve 40 and the spool 61 of the second neutral cut valve 60 are accommodated in the same first accommodating hole 31 has been described as an example, and the spool 41 of the first neutral cut valve 40 and the spool 61 of the second neutral cut valve 60 may be accommodated in separate accommodating holes. If there is a space in the valve block 3, the spool 41 of the first neutral cut valve 40 and the spool 61 of the second neutral cut valve 60 may be displaced from each other.

In the fluid pressure control device 100, the first relief valve 81 of the first circuit system 10 is also provided in the second region R2. The first neutral cut valve 40 is provided between the first relief valve 81 and the flow rate control valve 70 provided in the first region R1 in a cross section (a cross section orthogonal to the longitudinal direction of the valve block 3) shown in FIG. 2. With such a configuration, a dead space in the second region R2 can be effectively used, and an increase in size of the valve block 3 can be prevented.

In the above embodiment, a case where the regeneration release valve 50 and the flow rate control valve 70 are provided in the first circuit system 10 has been described as an example. Instead, a valve such as the regeneration release valve 50 or the flow rate control valve 70 may be provided in the second circuit system 20. In this case, the first neutral cut valve 40 and the second neutral cut valve 60 may be provided in the first region R1.

In the above embodiment, a case where the regeneration release valve 50 and the flow rate control valve 70 are provided in the first circuit system 10 has been described as an example, but the present invention is not limited thereto, and the present invention can also be applied to a case where another function valve such as a speed switching valve for switching a speed of the arm cylinder 90 is provided. Furthermore, the first circuit system 10 may not include the regeneration release valve 50 and the flow rate control valve 70. Even in this case, by providing the first neutral cut valve 40 and the second neutral cut valve 60 in either the first region R1 or the second region R2, a space where the first neutral cut valve 40 and the second neutral cut valve 60 do not exist can be removed.

In the above embodiment, the flow rate control valve 70 is of an external pilot type, but the present invention is not limited thereto, and the flow rate control valve 70 may be of an internal pilot type in which a load pressure of any actuator is used as, for example, a pilot pressure.

The configuration, operation, and effect of the embodiment of the present invention configured as described above will be collectively described.

The fluid pressure control device 100 includes the first circuit system 10 that includes at least one first control valve 121 to 125 connected to the first pump P1 and controls an actuator, the second circuit system 20 that includes at least one second control valve 221 to 224 connected to the second pump P2 and controls an actuator, and the valve block 3 that has a first region R1 in which the first control valves 121 to 125 are accommodated and a second region R2 in which the second control valves 221 to 224 are accommodated. The first circuit system 10 includes the first neutral passage 11 that recirculates a working fluid of the first pump P1 to the tank T when all the first control valves 121 to 125 are in the neutral positions, and the first neutral cut valve 40 that is provided downstream of the first control valves 121 to 125 in the first neutral passage 11 and allows or shuts off the communication between the first neutral passage 11 and the tank T. The second circuit system 20 includes the second neutral passage 21 that recirculates a working fluid of the second pump P2 to the tank T when all the second control valves 221 to 224 are in the neutral positions, and the second neutral cut valve 60 that is provided downstream of the second control valves 221 to 224 in the second neutral passage 21 and allows or shuts off the communication between the second neutral passage 21 and the tank T. The first neutral cut valve 40 and the second neutral cut valve 60 are accommodated in either the first region R1 or the second region R2.

In this configuration, since the first neutral cut valve 40 and the second neutral cut valve 60 are accommodated in either the first region R1 or the second region R2, for example, when the first neutral cut valve 40 is newly added, the first neutral cut valve 40 can be accommodated in the second region R2 in which the second neutral cut valve 60 has been already provided. Therefore, there is no need to newly secure a space for accommodating the first neutral cut valve 40 to be added. Accordingly, an increase in size of the fluid pressure control device 100 can be prevented.

In the fluid pressure control device 100, the first neutral cut valve 40 includes the spool 41 (a first spool) that shuts off or allows the communication between the first neutral passage 11 and the tank T, the second neutral cut valve 60 includes the spool 61 (a second spool) that shuts off or allows the communication between the second neutral passage 21 and the tank T, and the spool 41 (the first spool) and the spool 61 (the second spool) are disposed coaxially.

In this configuration, the spool 41 (the first spool) of the first neutral cut valve 40 and the spool 61 (the second spool) of the second neutral cut valve 60 are disposed coaxially with each other. Therefore, as compared with a case where the spool 41 (the first spool) of the first neutral cut valve 40 and the spool 61 (the second spool) of the second neutral cut valve 60 are displaced from each other, an increase in size of the fluid pressure control device 100 can be prevented.

In the fluid pressure control device 100, the spool 41 (the first spool) and the spool 61 (the second spool) are accommodated in the same through hole (the first accommodating hole 31) formed in the valve block 3.

In this configuration, since the spool 41 (the first spool) of the first neutral cut valve 40 and the spool 61 (the second spool) of the second neutral cut valve 60 are accommodated in the same through hole (the first accommodating hole 31) formed in the valve block 3, the number of processing steps can be reduced as compared with a case where the spool 41 (the first spool) and the spool 61 (the second spool) are provided in separate accommodating holes.

In the fluid pressure control device 100, the first circuit system 10 further includes the first relief valve 81 that is provided downstream of the first neutral cut valve 40 in the first neutral passage 11 and defines the maximum pressure in the first neutral passage 11, the second circuit system 20 further includes the second relief valve 82 that is provided downstream of the second neutral cut valve 60 in the second neutral passage 21 and defines the maximum pressure in the second neutral passage 21, and the first neutral cut valve 40, the second neutral cut valve 60, the first relief valve 81, and the second relief valve 82 are provided in the same region either the first region R1 or the second region R2.

In this configuration, by effectively using a dead space generated in the first region R1 or the second region R2, an increase in size of the valve block 3 can be prevented.

Although the embodiment of the present invention has been described above, the above embodiment is merely a part of the application of the present invention, and the technical scope of the present invention is not limited to the specific configuration of the above embodiment.

In the above embodiment, a case where valve block 3 is formed by a single member has been described as an example, the valve block 3 may be formed by stacking a plurality of blocks, or valve blocks corresponding to the first region R1 and the second region R2 may be provided.

This application claims priority based on Japanese Patent Application No.2022-200315 filed with the Japan Patent Office on Dec. 15, 2022, the entire contents of which are incorporated into this specification.

1. A fluid pressure control device comprising:
a first circuit system connected to a first pump and including at least one first control valve for controlling an actuator;
a second circuit system connected to a second pump and including at least one second control valve for controlling the actuator; and
a valve block including a first region in which the first control valve is accommodated and a second region in which the second control valve is accommodated, wherein
the first circuit system includes
a first neutral passage configured to recirculate a working fluid of the first pump to a tank when all the first control valves are in neutral positions, and
a first neutral cut valve provided downstream of the first control valve in the first neutral passage and configured to allow or shut off communication between the first neutral passage and the tank,
the second circuit system includes
a second neutral passage configured to recirculate a working fluid of the second pump to the tank when all the second control valves are in neutral positions, and
a second neutral cut valve provided downstream of the second control valve in the second neutral passage and configured to allow or shut off communication between the second neutral passage and the tank, and
the first neutral cut valve and the second neutral cut valve are accommodated in either the first region or the second region.

2. The fluid pressure control device according to claim 1, wherein
the first neutral cut valve includes a first spool configured to allow or shut off the communication between the first neutral passage and the tank,
the second neutral cut valve includes a second spool configured to allow or shut off the communication between the second neutral passage and the tank, and
the first spool and the second spool are disposed coaxially.

3. The fluid pressure control device according to claim 2, wherein
the first spool and the second spool are accommodated in the same through hole formed in the valve block.

4. The fluid pressure control device according to claim 1, wherein
the first circuit system further includes
a first relief valve provided downstream of the first neutral cut valve in the first neutral passage and configured to define a maximum pressure in the first neutral passage,
the second circuit system further includes
a second relief valve provided downstream of the second neutral cut valve in the second neutral passage and configured to define a maximum pressure in the second neutral passage, and
the first neutral cut valve, the second neutral cut valve, the first relief valve, and the second relief valve are provided in the same region either the first region or the second region.
